(19) United States
(12) Patent Application Publication
(10) Pub. No.: US 2022/0244660 A1
(43) Pub. Date: Aug. 4, 2022

(54) IMAGE FORMING APPARATUS

(71) Applicant: TOSHIBA TEC KABUSHIKI KAISHA, Tokyo (JP)

(72) Inventor: Hideaki FUKAYA, Sunto Shizuoka (JP)

(73) Assignee: TOSHIBA TEC KABUSHIKI KAISHA, Tokyo (JP)

(21) Appl. No.: 17/167,331

(22) Filed: Feb. 4, 2021

(51) Int. Cl. G03G 15/08

(52) U.S. Cl. CPC G03G 15/0849; G03G 2215/0888

(57) ABSTRACT

An image forming apparatus includes an image carrier, a developer, a toner conveyer, a toner replenisher, a toner, and a processor. The image carrier is configured to hold an electrostatic latent image. The developer is configured to form a toner image by causing toner to adhere to the electrostatic latent image. The toner conveyer is configured to convey the toner in the developer. The toner replenisher is configured to replenish the developer with the toner. The toner concentration sensor is configured to detect a concentration of the toner in the developer. The processor configured to: determine a toner replenishment amount; determine an estimated toner concentration value from the toner replenishment amount; receive the concentration from the toner concentration sensor; determine a measured toner concentration value based on the concentration; and cause the toner replenisher to replenish the developer with the toner replenishment amount.

### FIELD

Embodiments described herein relate generally to image forming apparatuses.

### BACKGROUND

An image forming apparatus includes a process unit, an exposing device, a transfer mechanism, a fixing device, and the like, for each color. The process unit includes a photoreceptor, a developing device, and a toner replenishment mechanism. The image forming apparatus irradiates a charged and rotating photoreceptor with a laser beam based on an image by an exposing device to form an electrostatic latent image on the photoreceptor. The image forming apparatus adheres toner to the electrostatic latent image on the photoreceptor by the developing device to form a toner image on the photoreceptor. The image forming apparatus replenishes the developing device with toner by the toner replenishment mechanism. The image forming apparatus transfers the toner image on the photoreceptor to a recording medium, such as paper, by a transfer mechanism. The image forming apparatus fixes the toner image transferred to the recording medium by the fixing device.

The image forming apparatus determines a toner replenishment amount based on the image used for forming the electrostatic latent image. The image forming apparatus replenishes the developing device with the toner by operating the toner replenishment mechanism in response to the determined toner replenishment amount. A stirring/circulating mechanism for stirring and circulating a toner and a carrier is provided in the developing device. The stirring/circulating mechanism stirs the toner so that the toner is uniformly distributed in the developing device and circulates the toner in a circulation path in the developing device.

However, in a case where there is a difference between the toner replenishment amount and the amount of toner actually replenished to the developing device by operating the toner replenishment mechanism in response to the toner replenishment amount, there is a problem that the toner may not be uniformly distributed in the developing device.

### DESCRIPTION OF THE DRAWINGS

FIG. 1 is a diagram illustrating a configuration example of an image forming apparatus according to a first embodiment;

FIG. 2 is a diagram illustrating a configuration example of an image forming unit of the image forming apparatus;

FIG. 3 is a diagram illustrating a configuration example of the image forming unit;

FIG. 4 is an explanatory diagram illustrating circulation of toner in the image forming unit;

FIG. 5 is an explanatory diagram illustrating an example of operations of the image forming apparatus;

FIG. 6 is a diagram illustrating an example of a control table; and

FIG. 7 is a diagram illustrating a configuration example of an image forming unit according to a second embodiment.

### DETAILED DESCRIPTION

According to one embodiment, there is provided an image forming apparatus including: an image carrier that holds an electrostatic latent image; a developing device that forms a toner image by adhering toner to the electrostatic latent image; a toner conveyance mechanism that conveys the toner in the developing device; a toner replenishment mechanism that replenishes the developing device with the toner; a toner concentration sensor that detects a toner concentration of the developing device; and a controller that determines a toner replenishment amount, determines operations of the toner replenishment mechanism and the toner conveyance mechanism based on the determined toner replenishment amount, calculates a predicted (estimated) toner concentration value from the toner replenishment amount, and controls the operations of the toner replenishment mechanism and the toner conveyance mechanism based on a result of a comparison between a measured toner concentration value detected by the toner concentration sensor and the predicted toner concentration value if toner replenishment is performed by the toner replenishment mechanism.

Hereinafter, the image forming apparatus according to the embodiment will be described with reference to the drawings.

### First Embodiment

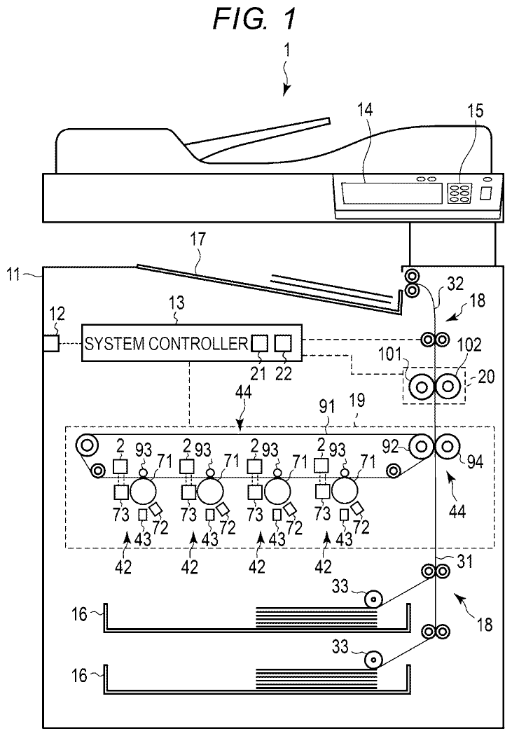

FIG. 1 is an explanatory diagram illustrating a configuration example of an image forming apparatus 1 according to a first embodiment.

The image forming apparatus 1 is, for example, a multifunction printer (MFP) that performs various processes, such as image forming, while conveying a recording medium. The image forming apparatus 1 is, for example, a solid-state scanning printer using a light emitting diode (LED) array, a laser scanning unit (LSU) printer having a polygon mirror, or other type printers.

The image forming apparatus 1 forms an image on the recording medium by using the toner replenished from the toner cartridge. The image forming apparatus 1 receives toner from each of a plurality of toner cartridges 2 holding toners of different colors, such as cyan, magenta, yellow, and black, and forms a toner image.

As illustrated in FIG. 1, the image forming apparatus 1 includes a housing 11, a communication interface 12, a system controller 13 (processor), a display unit 14, an operation interface 15, a paper feed cassette 16, a paper discharge tray 17, a conveyance mechanism 18, an image forming unit 19, and a fixing device 20.

The housing 11 is a main body of the image forming apparatus 1. The housing 11 accommodates the communication interface 12, the system controller 13, the conveyance mechanism 18, the image forming unit 19, and the fixing device 20. In addition, the display unit 14, the operation interface 15, the paper feed cassette 16, and the paper discharge tray 17 are provided to the housing 11 so as to be accessible from outside of the housing 11.

The communication interface 12 is an interface that facilitates communication with other devices. The communication interface 12 is used for communication with, for example, a client. The client is, for example, an information processing device such as a personal computer, a smartphone, or a tablet personal computer (PC). The communication interface 12 is configured as, for example, a local area network (LAN) connector or the like. In addition, the communication interface 12 may be configured to perform wireless communication with the client in accordance with a standard such as Bluetooth® or Wi-Fi®.

The system controller 13 controls the image forming apparatus 1. The system controller 13 includes, for example, a processor 21 and a memory 22. The processor 21 is known to the person of ordinary skill in the art, e.g., an arithmetic element executing arithmetic processing. The processor 21 is, for example, a central processing unit (CPU). The processor 21 performs various processes based on data, such as a program, stored in the memory 22. The processor 21 functions as a control unit capable of executing various operations by executing the program stored in the memory 22. The memory 22 is a storage medium for storing the program and data used in the program. In addition, the memory 22 also functions as a working memory. That is, the memory 22 temporarily stores the data being processed by the processor 21, the program executed by the processor 21, and the like. The processor 21 performs various information processing by executing the program stored in the memory 22. For example, the processor 21 controls transmission and reception of data by the communication interface 12, screen display by the display unit 14, operation input by the operation interface 15, conveying of the recording medium by the conveyance mechanism 18, an image forming process by the image forming unit 19, a fixing process by the fixing device 20, and the like. In addition, the processor 21 generates a print job based on an image acquired from an external device via the communication interface 12. The processor 21 stores the generated print job in the memory 22.

The print job includes image data indicating the image formed on the recording medium. The image data may be data for forming the image on one recording medium or may be data for forming the image on a plurality of recording media. Furthermore, the print job contains information indicating whether the print is a color print or a monochrome print.

In addition, the image forming apparatus 1 may be configured with a conveyance controller that controls the conveying of the recording medium by the conveyance mechanism 18, the image forming process by the image forming unit 19, the fixing process by the fixing device 20, and the like, separately from the system controller 13. In this case, the system controller 13 supplies information required for control in the conveyance controller to the conveyance controller.

The display unit 14 includes a display that displays a screen in response to an input video signal. For example, a screen and the like for various setting of the image forming apparatus 1 can be displayed in the display of the display unit 14.

The operation interface 15 has an operation member that generates an operation signal based on the operation of the user.

The paper feed cassette 16 is a cassette that stores the recording medium. The paper feed cassette 16 is configured so as to be able to supply the recording medium from the outside of the housing 11. For example, the paper feed cassette 16 is configured so as to be able to pull the recording medium out from the housing 11.

The paper discharge tray 17 is a tray for supporting the recording medium discharged from the image forming apparatus 1.

The conveyance mechanism 18 is configured to supply the recording medium for printing to the image forming unit 19 and discharge the recording medium on which the image is formed by the image forming unit 19 from the housing. For example, the conveyance mechanism 18 includes a paper feed conveyance path 31 and a paper discharge conveyance path 32.

Each of the paper feed conveyance path 31 and the paper discharge conveyance path 32 moves the recording medium.

The paper feed conveyance path 31 takes in the recording medium from the paper feed cassette 16 and supplies the taken-in recording medium to the image forming unit 19. The paper feed conveyance path 31 includes a pickup roller 33 corresponding to each paper feed cassette 16. Each pickup roller 33 takes in the recording medium of the paper feed cassette 16 into the paper feed conveyance path 31.

The paper discharge conveyance path 32 is a conveyance path for discharging the recording medium on which the image is formed from the housing 11. The recording medium discharged by the paper discharge conveyance path 32 is supported by the paper discharge tray 17.

Next, the image forming unit 19 will be described.

The image forming unit 19 is configured to form an image on the recording medium. Specifically, the image forming unit 19 forms an image on the recording medium based on the print job generated by the processor 21.

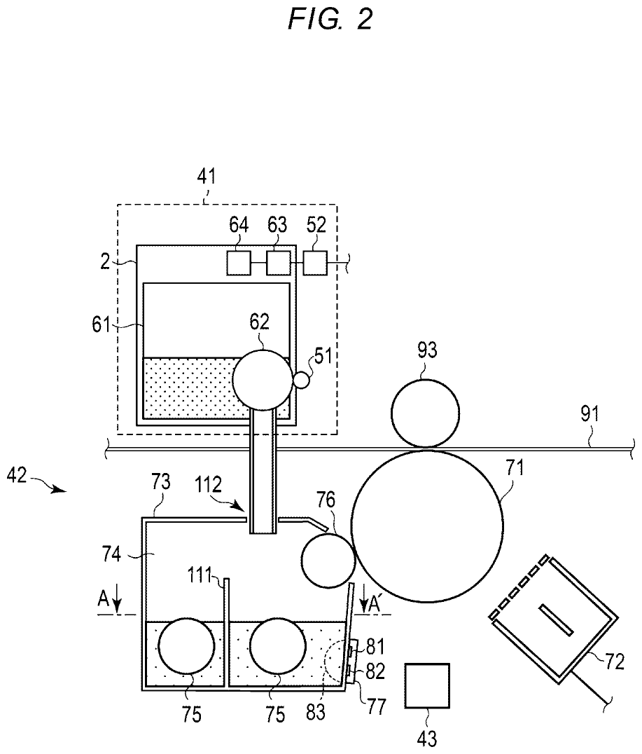

FIG. 2 is an explanatory diagram illustrating an example of a partial configuration of the image forming unit 19.

The image forming unit 19 includes a plurality of loading units 41 (loader), a plurality of process units 42 (processors, formers), a plurality of exposing devices 43 (exposer), and a transfer mechanism 44 (transferor). The plurality of process units 42 are provided for each type of toner. For example, the plurality of process units 42 can correspond to respective color toners such as cyan, magenta, yellow, and black. Toner cartridges 2 having toners of different colors are connected to the respective process units 42. The loading unit 41 and the exposing device 43 are provided for each process unit 42. That is, the loading unit 41 and the exposing device 43 are provided for each color, such as cyan, magenta, yellow, and black. In addition, since the plurality of loading units 41, the plurality of process units 42, and the plurality of exposing devices 43 have the same configuration, one process unit 42, one loading unit 41, and one exposing device 43 will be described.

First, the loading unit 41 on which the toner cartridge 2 is mounted will be described.

As illustrated in FIG. 2, the loading unit 41 is a module in which toner cartridges 2 filled with respective toners are mounted. The loading unit 41 includes a space in which each toner cartridge 2 is mounted, a toner replenishment motor 51, and a toner cartridge communication interface 52. The toner replenishment motor 51 drives the toner delivery mechanism of the toner cartridge 2 under the control of the processor 21. The toner replenishment motor 51 is configured to be able to transmit a driving force to the toner delivery mechanism of the toner cartridge 2 in a case where the toner cartridge 2 is loaded in the loading unit 41.

The toner cartridge communication interface 52 communicates with the toner cartridge 2. In a case where the toner cartridge 2 is loaded in the loading unit 41, the toner cartridge communication interface 52 is connected to the communication interface of the toner cartridge 2.

Next, the toner cartridge 2 will be described.

As illustrated in FIG. 2, the toner cartridge 2 includes a toner storage container 61, a toner delivery mechanism 62 (toner deliverer), a communication interface 63, and an integrated circuit (IC) chip 64. The toner storage container 61 is a container for storing toner.

The toner delivery mechanism 62 delivers the toner in the toner storage container 61. The toner delivery mechanism 62 is, for example, a screw provided in the toner storage container 61 to deliver the toner by rotating. The toner delivery mechanism 62 is driven by the toner replenishment motor 51. In addition, the toner cartridge 2 maybe configured to include a motor for rotating the toner delivery mechanism 62. The toner replenishment motor 51 and the toner delivery mechanism 62 of the toner cartridge 2 function as a toner replenishment mechanism (toner replenisher) for replenishing the developing device described later with toner from the toner cartridge 2. The communication interface 63 is an interface for communicating with the image forming apparatus 1. The communication interface 63 is connected to the toner cartridge communication interface 52 in a case where the toner cartridge 2 is mounted on the loading unit 41.

The IC chip 64 includes a memory in which various control data are stored in advance and a processor. The control data is, for example, an “identification code” and a “near empty threshold”. The “identification code” indicates the type, model number, and the like of the toner cartridge 2. The “near empty threshold value” is a threshold value for allowing the image forming apparatus 1 to determine whether or not the remaining amount of toner in the toner cartridge 2 is low.

Next, a plurality of the process units 42 will be described.

The process unit 42 is configured to form a toner image. The process unit 42 includes a photosensitive drum 71, a charging device 72 (charger), and a developing device 73 (developer).

The photosensitive drum 71 is a photoreceptor including a cylindrical drum and a photosensitive layer formed on an outer peripheral surface of the drum. The photosensitive drum 71 rotates at a constant speed. The charging device 72 uniformly charges the surface of the photosensitive drum 71. For example, the charging device 72 charges the photosensitive drum 71 to a uniform negative potential by applying a voltage to the photosensitive drum 71.

The developing device 73 is a device for adhering the toner to the photosensitive drum 71. The developing device 73 includes a developer container 74, a stirring/circulating mechanism 75 (toner conveyor, toner stirrer, toner circulator), a developing roller 76 (developer roller), a toner concentration sensor 77, and the like.

The developer container 74 is a container for storing a developer containing toner and a carrier. The developer container 74 is made of a resin. The developer container 74 receives the toner delivered from the toner storage container 61 of the toner cartridge 2 by the toner delivery mechanism 62. The carrier is stored in the developer container 74 during the manufacturing of the developing device 73.

The stirring/circulating mechanism 75 stirs and circulates the toner and the carrier in the developer container 74 by rotating. The stirring/circulating mechanism 75 functions as a toner conveyance mechanism for conveying toner in the developing device 73. The stirring/circulating mechanism 75 is, for example, an Auger screw.

The developing roller 76 rotates in the developer container 74 to adhere the developer to the surface of the developing roller 76. Accordingly, a layer of a developer having a predetermined (target) thickness is formed on the surface of the developing roller 76. The rotation axis of the developing roller 76 is configured to be parallel to the rotation axis of the photosensitive drum 71.

The toner concentration sensor 77 is a sensor that detects a toner concentration in the developer container 74. The toner concentration sensor is, for example, an electrostatic capacitance sensor. The toner concentration sensor 77 includes a first electrode 81 arranged in the developer container 74 and a second electrode 82 arranged apart from the first electrode 81. The first electrode 81 and the second electrode 82 are provided on the outer wall surface of the developer container 74. For example, the first electrode 81 and the second electrode 82 are provided so as to be in contact with the outer wall surface of the developer container 74. The first electrode 81 and the second electrode 82 are formed as a wiring pattern on, for example, a resin substrate. The first electrode 81 and the second electrode 82 may be two electrodes divided in the vertical direction or may be two electrodes divided in the longitudinal direction.

The toner concentration sensor 77 detects the electrostatic capacitance between the first electrode 81 and the second electrode 82. The toner concentration sensor 77 transmits a signal corresponding to the change in electrostatic capacitance between the first electrode 81 and the second electrode 82 to the system controller 13 as a detection result.

The electrostatic capacitance between the first electrode 81 and the second electrode 82 changes according to an amount of toner in a detection range 83 formed between the first electrode 81 and the second electrode 82. The system controller 13 can determine the toner concentration ratio of the toner to the carrier in the developer container 74 based on a detection voltage of the toner concentration sensor 77. That is, the processor 21 of the system controller 13 can calculate the measured toner concentration value which is an actual value of the toner concentration in the detection range 83 based on the detection result from the toner concentration sensor 77.

Next, the exposing device 43 will be described.

The exposing device 43 includes a plurality of light emitting elements. The exposing device 43 forms a latent image on the photosensitive drum 71 by irradiating the charged photosensitive drum 71 with light from the light emitting element. The light emitting element is, for example, an LED. One light emitting element is configured to irradiate one point on the photosensitive drum 71 with light. The plurality of light emitting elements are arranged in a main scanning direction which is a direction parallel to the rotation axis of the photosensitive drum 71.

The exposing device 43 forms the latent image for one line on the photosensitive drum 71 by irradiating the photosensitive drum 71 with light by a plurality of light emitting elements arranged in the main scanning direction. Furthermore, the exposing device 43 forms the latent image for a plurality of lines by continuously irradiating the rotating photosensitive drum 71 with light.

In the above-described configuration, if the surface of the photosensitive drum 71 charged by the charging device 72 is irradiated with light from the exposing device 43, the electrostatic latent image is formed. If the layer of the developer formed on the surface of the developing roller 76 is close to the surface of the photosensitive drum 71, the toner contained in the developer adheres to the latent image formed on the surface of the photosensitive drum 71. Accordingly, the toner image is formed on the surface of the photosensitive drum 71. That is, the photosensitive drum 71 functions as an image carrier that holds an electrostatic latent image and holds a toner image adhered to the electrostatic latent image.

Next, the transfer mechanism 44 will be described.

The transfer mechanism 44 is configured to transfer the toner image formed on the surface of the photosensitive drum 71 to the recording medium. The transfer mechanism 44 includes, for example, a primary transfer belt 91, a secondary transfer facing roller 92, a plurality of primary transfer rollers 93, and a secondary transfer roller 94.

The primary transfer belt 91 is an endless belt wound around the secondary transfer facing roller 92, the primary transfer rollers 93, and a plurality of winding rollers. In the primary transfer belt 91, the inner peripheral surface which is the inner surface is in contact with the secondary transfer facing roller 92 and the plurality of winding rollers, and the outer peripheral surface which is the outer surface faces the photosensitive drum 71 of the process unit 42.

The secondary transfer facing roller 92 rotates to convey the primary transfer belt 91 in a predetermined conveyance direction. The plurality of winding rollers are configured to be freely rotatable. The plurality of winding rollers rotate according to the movement of the primary transfer belt 91 by the secondary transfer facing roller 92.

The plurality of primary transfer rollers 93 are configured to bring the primary transfer belt 91 into contact with the photosensitive drums 71 of the plurality of process units 42, respectively. The plurality of primary transfer rollers 93 are provided so as to correspond to (e.g., be aligned with, be disposed adjacent to, etc.) the photosensitive drums 71 of the plurality of process units 42. Specifically, each of the plurality of primary transfer rollers 93 is provided at a location facing the photosensitive drum 71 of the corresponding process unit 42 with the primary transfer belt 91 interposed therebetween. The primary transfer roller 93 is in contact with the inner peripheral surface side of the primary transfer belt 91 and displaces the primary transfer belt 91 toward the photosensitive drum 71. Accordingly, the primary transfer roller 93 brings the outer peripheral surface of the primary transfer belt 91 into contact with the photosensitive drum 71.

The secondary transfer roller 94 is provided at a location facing the primary transfer belt 91. The secondary transfer roller 94 is in contact with the outer peripheral surface of the primary transfer belt 91 and applies pressure. Accordingly, a transfer nip is formed in which the secondary transfer roller 94 and the outer peripheral surface of the primary transfer belt 91 are in close contact with each other. If the recording medium passes through the transfer nip, the secondary transfer roller 94 presses the recording medium passing through the transfer nip against the outer peripheral surface of the primary transfer belt 91.

The secondary transfer roller 94 and the secondary transfer facing roller 92 rotate to convey the recording medium supplied from the paper feed cassette 16 by the conveyance mechanism 18 in an interposed state. Accordingly, the recording medium passes through the transfer nip.

In the above-described configuration, if the outer peripheral surface of the primary transfer belt 91 is in contact with the photosensitive drum 71, the toner image formed on the surface of the photosensitive drum 71 is transferred to the outer peripheral surface of the primary transfer belt 91. In a case where the image forming unit 19 includes the plurality of process units 42, the primary transfer belt 91 receives the toner image from the photosensitive drums 71 of the plurality of process units 42. The toner image transferred to the outer peripheral surface of the primary transfer belt 91 is conveyed to the transfer nip in which the secondary transfer roller 94 and the outer peripheral surface of the primary transfer belt 91 are in close contact with each other by the primary transfer belt 91. In a case where the recording medium is present in the transfer nip, the toner image transferred to the outer peripheral surface of the primary transfer belt 91 is transferred to the recording medium in the transfer nip.

Next, a configuration related to fixing of the image forming apparatus 1 will be described.

The fixing device 20 melts the toner transferred to the recording medium and fixes the toner image. The fixing device 20 operates under the control of the system controller 13. The fixing device 20 includes a heating member that applies heat to the recording medium and a pressing member that applies pressure to the recording medium. For example, the heating member is, for example, a heat roller 101. In addition, for example, the pressing member is a press roller 102.

The heat roller 101 is a rotating body for fixing that rotates. The heat roller 101 has a metal core made of a metal in a hollow shape and an elastic layer formed on the outer periphery of the metal core. The heat roller 101 is heated to a high temperature by a heater arranged inside the metal core formed in a hollow shape. The heater is, for example, a halogen heater. In addition, the heater may be an induction heating (IH) heater that heats the metal core by electromagnetic induction.

The press roller 102 is provided at a location facing the heat roller 101. The press roller 102 has a metal core made of a metal having a predetermined outer diameter and an elastic layer formed on the outer periphery of the metal core. The press roller 102 applies pressure to the heat roller 101. If pressure is applied from the press roller 102 to the heat roller 101, a fixing nip in which the press roller 102 and the heat roller 101 are in close contact with each other is formed. The press roller 102 rotates to move the recording medium that enters the fixing nip and to press the recording medium against the heat roller 101.

With the above-described configuration, the heat roller 101 and the press roller 102 apply heat and pressure to the recording medium passing through the fixing nip. Accordingly, the toner image is fixed on the recording medium that passes through the fixing nip. The recording medium that passes through the fixing nip is discharged to the outside of the housing 11 by the conveyance mechanism 18. The fixing device 20 is not limited to the above-described configuration. The fixing device 20 may be configured by an on-demand method in which heat is applied to the recording medium on which the toner image is transferred via a film-like member to melt and fix the toner.

Next, the developing device 73 will be described in detail.

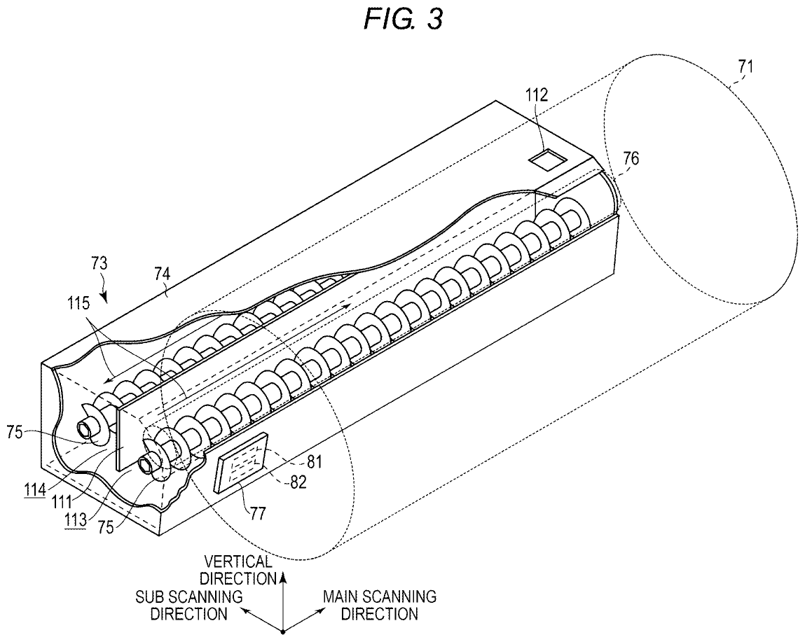

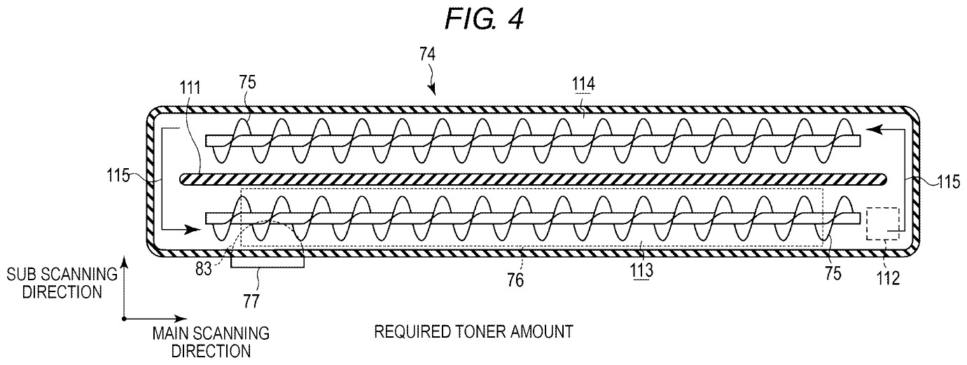

FIG. 3 is a perspective view illustrating the developer container 74 of the developing device 73 of which a portion is cut away. FIG. 4 is a cross-sectional view of the developer container 74 of the developing device 73 taken along the line AA′ in FIG. 2.

As illustrated in FIGS. 2 to 4, a partition member 111 and a toner replenishment port 112 are provided in the developer container 74.

The developer container 74 has a longitudinal direction and a lateral direction as illustrated in FIGS. 3 and 4. The longitudinal direction of the developer container 74 is a direction parallel to the rotation axis of the developing roller 76. That is, the longitudinal direction of the developer container 74 is a direction parallel to the main scanning direction.

The partition member 111 partitions the inside of the developer container 74 to form a toner circulation path, that is, a toner conveyance path in the developer container 74. The partition member 111 divides the space inside the developer container 74 into a main scanning direction and a sub scanning direction perpendicular to the vertical direction over a predetermined distance in the main scanning direction. Specifically, as illustrated in FIGS. 3 and 4, the partition member 111 divides the space inside the developer container 74 into a first space 113 and a second space 114. In addition, the partition member 111 is formed so that the first space 113 and the second space 114 are connected at the end portion in the main scanning direction. In addition, the partition member 111 maybe integrally configured with the developer container 74.

In addition, the stirring/circulating mechanism 75 is arranged in each space partitioned by the partition member 111. That is, the stirring/circulating mechanism 75 is arranged in each of the first space 113 and the second space 114. In addition, the developing roller 76 is arranged in the first space 113.

The stirring/circulating mechanism 75 arranged in the first space 113 and the stirring/circulating mechanism 75 arranged in the second space 114 rotate so as to circulate the toner in directions reverse to each other.

Accordingly, the stirring/circulating mechanism 75 arranged in the first space 113 and the stirring/circulating mechanism 75 arranged in the second space 114 circulate the toner while stirring the toner in the developer container 74. Specifically, as illustrated in FIG. 4, the stirring/circulating mechanism 75 arranged in the first space 113 and the stirring/circulating mechanism 75 arranged in the second space 114 circulate the toner in the developer container 74 in a circulation direction 115. In addition, the toner circulation speed in the developer container 74, that is, the toner conveyance speed changes according to the rotation speed of the stirring/circulating mechanism 75 arranged in the first space 113 and the stirring/circulating mechanism 75 arranged in the second space 114. The toner replenishment port 112 is a replenishment port for receiving toner. The toner replenishment port 112 is configured so as to be able to receive the toner delivered from the toner cartridge 2 by the operation of the toner replenishment mechanism. As illustrated in FIGS. 3 and 4, the toner replenishment port 112 is provided at the location farthest from the developing roller 76 in the toner circulation path. The toner replenishment port 112 is provided downstream of the developing roller 76 in the toner circulation path. Accordingly, the replenished toner is sufficiently stirred until the replenished toner reaches the developing roller 76, and the distribution of the toner concentration can be dispersed.

In addition, as illustrated in FIGS. 3 and 4, the toner concentration sensor 77 is provided so that the detection range 83 is arranged in the vicinity of the developing roller 76. More specifically, the toner concentration sensor 77 is provided so that the detection range 83 is arranged in the vicinity of the developing roller 76 and on the upstream side of the toner circulation path. Accordingly, the toner concentration sensor 77 can detect the toner concentration after the toner replenished from the toner replenishment port 112 is sufficiently stirred by the stirring/circulating mechanism 75 in the second space 114.

According to the above-described configuration, the toner replenished from the toner replenishment port 112 moves from the first space 113 to the second space 114 and moves in the circulation direction 115 while being stirred by the stirring/circulating mechanism 75 in the second space 114. Furthermore, the toner moves from the second space 114 to the first space 113 and moves while being stirred by the stirring/circulating mechanism 75 in the first space 113. Accordingly, the toner passes through the detection range 83 of the toner concentration sensor 77 and moves to the vicinity of the developing roller 76. In this manner, the toner replenished from the toner replenishment port 112 circulates in the second space 114 and the first space 113 by the stirring/circulating mechanism 75.

Next, control related to toner replenishment will be described.

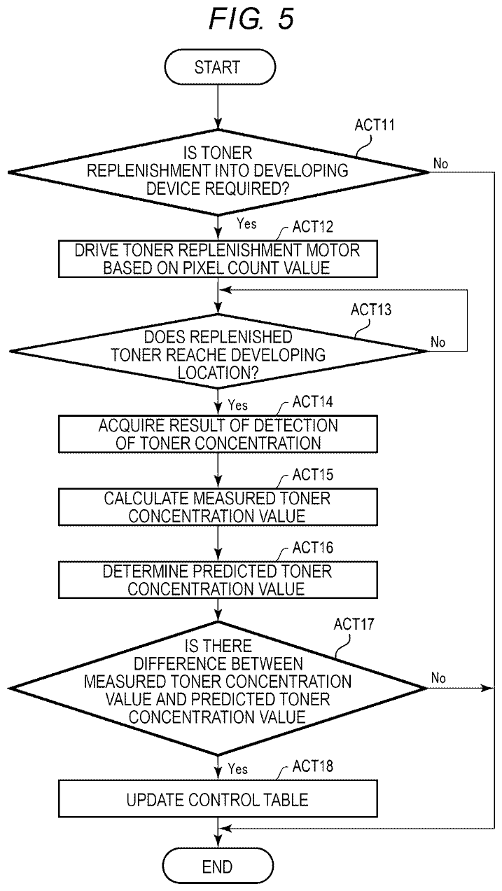

FIG. 5 is a flowchart for explaining control of the system controller 13 related to the toner replenishment by the processor 21.

The processor 21 first determines whether or not the toner replenishment into the developing device 73 is required (ACT11). For example, the processor 21 determines that toner replenishment is required when performing printing.

In a case where the processor 21 determines that the toner replenishment into the developing device 73 is required (YES in ACT11), the processor 21 drives the toner replenishment motor 51 based on a pixel count value (ACT12). The processor 21 determines the toner replenishment amount from, for example, the image data used for printing. For example, the processor 21 calculates the pixel count value indicating the amount of toner required for the image formation for each color based on the image data used for printing. The processor 21 determines the toner replenishment amount based on the calculated pixel count value.

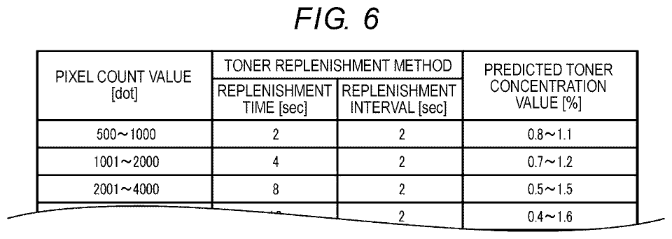

Furthermore, the processor 21 determines the driving time of the toner replenishment motor 51, that is, the replenishment time, based on the toner replenishment amount. The processor 21 operates the toner replenishment motor 51 for the determined replenishment time. In addition, the processor 21 determines the replenishment time of the toner replenishment motor 51 from the toner replenishment amount based on a preset control table. FIG. 6 is an explanatory diagram illustrating an example of the control table.

The control table is stored in, for example, the memory 22. In addition, the control table may be stored in another device capable of communicating via the communication interface 12. As illustrated in FIG. 6, the control table is a table in which, for example, a pixel count value, a toner replenishment method, and a predicted (estimated) toner concentration value are associated with each other. In addition, the control table may be a table in which, for example, the toner replenishment amount calculated based on the pixel count value, the toner replenishment method, and the predicted toner concentration value are associated with each other.

For the toner replenishment method, for example, a replenishment time and a replenishment interval are used.

The replenishment time is set based on the toner replenishment amount per unit time of the toner replenishment mechanism. That is, the replenishment time is a time required for the toner replenishment mechanism to replenish with the toner replenishment amount calculated based on the associated pixel count value.

The replenishment interval is a time interval of the toner replenishment by the toner replenishment mechanism. For example, at intervals of a predetermined time, the state in which the toner replenishment is performed and the state in which the toner replenishment is not performed may be switched according to the replenishment interval.

The predicted toner concentration value indicates a range of the toner concentration allowed after the toner replenishment. For example, the predicted toner concentration value indicates an upper limit and a lower limit of the toner concentration to be compared with the measured toner concentration value which is an actual toner concentration in the detection range 83 of the toner concentration sensor 77.

The processor 21 determines the toner replenishment method corresponding to the calculated pixel count value with reference to the control table. That is, the processor 21 determines the replenishment time and the replenishment interval corresponding to the calculated pixel count value. The processor 21 operates the toner replenishment motor 51 based on the determined replenishment time and the determined replenishment interval. That is, the processor 21 controls the toner replenishment motor 51 so as to determine the required toner replenishment amount, determine the toner replenishment method by the toner replenishment mechanism based on the determined toner replenishment amount, and perform the toner replenishment according to the determined toner replenishment method. Accordingly, the toner delivery mechanism 62 of the toner cartridge 2 operates, and the toner is replenished from the toner cartridge 2 to the developing device 73.

In addition, the processor 21 controls the operation of the stirring/circulating mechanism 75 so that the stirring and circulation of the toner by the stirring/circulating mechanism 75 are continuously performed. Accordingly, the toner replenished from the toner replenishment port 112 into the developer container 74 moves along the circulation path in the developer container 74.

The processor 21 determines whether or not the toner replenished from the toner replenishment port 112 into the developer container 74 reaches the developing location (ACT13). The processor 21 waits until the toner replenished from the toner replenishment port 112 into the developer container 74 reaches the developing location.

The developing location is a location of the developing roller 76 of the developing device 73. That is, the processor 21 determines whether or not the toner replenished from the toner replenishment port 112 into the developer container 74 reaches the location of the developing roller 76 in the circulation path in the developer container 74.

In addition, the detection range 83 of the toner concentration sensor 77 is provided in the vicinity of the developing roller 76 and on the upstream side of the toner circulation path. Therefore, it may be stated that the processor 21 determines whether or not the toner replenished from the toner replenishment port 112 into the developer container 74 reaches the detection range 83 of the toner concentration sensor 77.

For example, the processor 21 determines whether or not the toner reaches the detection range 83 of the toner concentration sensor 77 based on the toner circulation speed by the stirring/circulating mechanism 75 in the developer container 74, the distance between the toner replenishment port 112 and the detection range 83 of the toner concentration sensor 77, and the start timing of the toner replenishment.

If the processor 21 determines that the toner replenished from the toner replenishment port 112 into the developer container 74 reaches the developing location (YES in ACT13), the processor 21 acquires the detection result from the toner concentration sensor 77 (ACT14).

The processor 21 calculates the measured toner concentration value based on the detection result acquired from the toner concentration sensor 77 (ACT15). In addition, the processor 21 may continuously acquire the detection result from the toner concentration sensor 77 and may calculate the measured toner concentration value based on the detection result at the timing when it is determined that the toner replenished from the toner replenishment port 112 into the developer container 74 reaches the development location.

In addition, the processor 21 determines the predicted toner concentration value (ACT16). For example, the processor 21 determines the predicted toner concentration value corresponding to the pixel count value calculated by ACT12 with reference to the control table. That is, the processor 21 determines the upper limit and the lower limit of the toner concentration to be compared with the measured toner concentration value. In addition, the processor 21 may perform the process described later by using a preset predicted (estimated) toner concentration value instead of using the predicted toner concentration value corresponding to the pixel count value. If the processor 21 calculates the measured toner concentration value by the above-described process and determines the predicted toner concentration value, the processor 21 determines whether or not there is a difference between the calculated measured toner concentration value and the predicted toner concentration value (ACT17). For example, the processor 21 determines whether or not the calculated measured toner concentration value is equal to or more than the lower limit and less than the upper limit indicated by the predicted toner concentration value. If the processor 21 determines that the calculated measured toner concentration value is equal to or more than the lower limit and less than the upper limit indicated by the predicted toner concentration value, the processor 21 determines that there is no difference between the calculated measured toner concentration value and the predicted toner concentration value. That is, if the calculated measured toner concentration value is less than the lower limit or equal to or more than the upper limit indicated by the predicted toner concentration value, the processor 21 determines that there is a difference between the calculated measured toner concentration value and the predicted toner concentration value.

In a case where there is a difference between the calculated measured toner concentration value and the predicted toner concentration value, there is a possibility that the toner replenishment amount per operating time of the toner replenishment mechanism which is the standard for calculating the replenishment time may be different from an actual value. Therefore, in a case where the processor 21 determines that there is a difference between the calculated measured toner concentration value and the predicted toner concentration value (YES in ACT17), the processor 21 updates the control table (ACT18) and ends the process of FIG. 5.

In addition, in a case where it is determined in ACT11 that the toner replenishment into the developing device 73 is not required (NO in ACT11), or in a case where it is determined in ACT17 that there is no difference between the measured toner concentration value and the predicted toner concentration value (NO in ACT17) , the processor 21 ends the process of FIG. 5 without updating the control table.

As described above, the processor 21 changes the toner replenishment method based on a result of a comparison between the measured toner concentration value detected by the toner concentration sensor 77 if the toner replenishment by the toner replenishment mechanism is performed and the predicted toner concentration value calculated from the toner replenishment amount. Accordingly, the processor 21 can control the toner so that the toner is uniformly distributed in the developing device 73 by changing the toner replenishment method if the measured toner concentration value and the predicted toner concentration value do not match each other.

In addition, the processor 21 performs the toner replenishment by the toner replenishment mechanism and, if the replenished toner reaches (is within) the detection range 83 of the toner concentration sensor 77, the processor 21 determines whether or not to change the toner replenishment method. In addition, the processor 21 determines whether or not the replenished toner reaches the detection range 83 of the toner concentration sensor 77 based on the toner circulation speed by the stirring/circulating mechanism 75 in the developer container 74, the distance between the toner replenishment port 112 and the detection range 83 of the toner concentration sensor 77, and the timing when the toner replenishment by the toner replenishment mechanism is started. Accordingly, the toner concentration sensor 77 can detect the toner concentration in a state where the replenished toner is dispersed in the developer container 74 and, thus, the distribution of the toner concentration is uniform.

In addition, the processor 21 may update the control table in ACT18 of FIG. 5. For example, the processor 21 changes the replenishment time of the toner replenishment mechanism in the toner replenishment method of the control table in response to the difference between the measured toner concentration value and the predicted toner concentration value. That is, the processor 21 changes the setting of the toner replenishment amount per replenishment time of the toner replenishment mechanism.

In addition, the processor 21 may increase or decrease the replenishment time of the toner replenishment mechanism in the toner replenishment method of the control table by a predetermined amount. Accordingly, the processor 21 increases or decreases the toner replenishment amount per replenishment time of the toner replenishment mechanism by a predetermined amount.

In addition, the processor 21 may change the operating speed of the toner replenishment motor 51 of the toner replenishment mechanism in response to the difference between the measured toner concentration value and the predicted toner concentration value. Accordingly, the processor 21 can increase or decrease the toner replenishment amount per replenishment time without changing the replenishment time.

In addition, the processor 21 may change the replenishment interval of toner by the toner replenishment mechanism in the toner replenishment method in response to the difference between the measured toner concentration value and the predicted toner concentration value. Accordingly, the toner replenishment mechanism can finely disperse and replenish the developing device 73 with the toner.

In addition, the processor 21 may change an operation start timing of the toner replenishment mechanism based on the timing when the toner replenished by the toner replenishment mechanism reaches the detection range 83 of the toner concentration sensor 77. In this case, the processor 21 determines whether or not the toner replenished by the toner replenishment mechanism reaches the detection range 83 based on the change in the detection result of the toner concentration sensor 77.

In addition, the processor 21 detects the distribution of the toner concentration in the toner circulation path in the developer container 74 based on the measured toner concentration value continuously acquired from the toner concentration sensor 77. Furthermore, the processor 21 may determine the operation start timing of the toner replenishment mechanism based on the distribution of the toner concentration. Accordingly, the processor 21 can control the toner replenishment mechanism so as to replenish a location where the toner concentration is low with the toner.

In addition, in the above-described embodiment, it has been described that the toner concentration sensor 77 detects the toner concentration in the detection range 83 determined by the arrangement of the first electrode 81 and the second electrode 82, but the embodiment is not limited to this configuration. The toner concentration sensor 77 may include a plurality of the first electrodes 81 and a plurality of the second electrodes 82 arranged at a plurality of locations in the main scanning direction in the toner circulation path in the developer container 74. Accordingly, the toner concentration sensor 77 can detect the toner concentration in each detection range 83 configured at the plurality of locations in the main scanning direction in the toner circulation path in the developer container 74. Accordingly, the processor 21 can control the toner replenishment mechanism so as to replenish a location where the toner concentration is low with the toner.

In some cases, the image forming apparatus 1 may change the printing speed according to the type of recording medium. In response to this, the processor 21 changes the operating speed of the stirring/circulating mechanism 75 in the developer container 74. Even in such a case, the processor 21 can detect the distribution of the toner concentration in the toner circulation path in the developer container 74. Accordingly, the processor 21 can control the toner replenishment mechanism so that the toner concentration becomes uniform.

### Second Embodiment

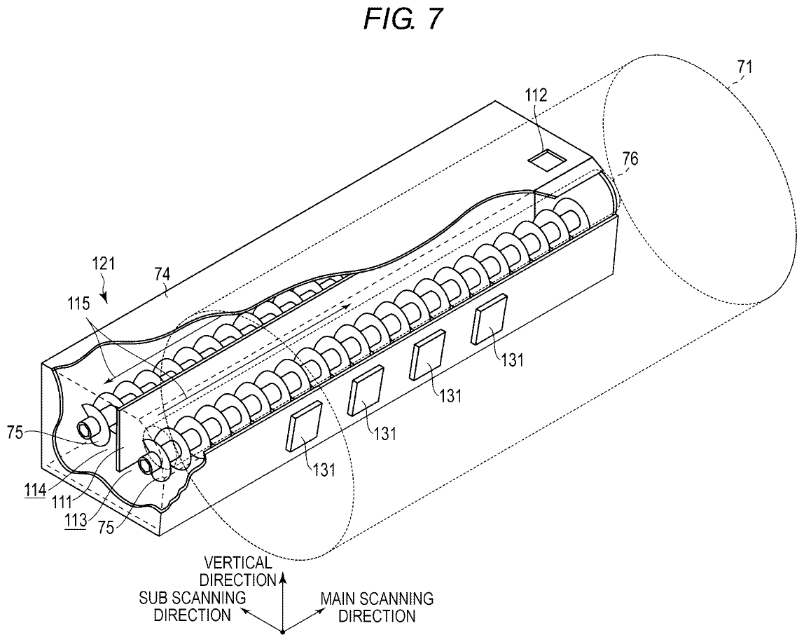

FIG. 7 is an explanatory diagram illustrating a configuration example of a developing device 121, which is a developing device according to a second embodiment. In addition, the same components as those in the first embodiment will be denoted by the same reference numerals, and detailed description thereof will be omitted. The developing device 121 according to the second embodiment is different from that according to the first embodiment in that a toner concentration sensor 131 configured with a coil is provided instead of the toner concentration sensor 77 configured with the electrostatic capacitance sensor.

The toner concentration sensor 131 is a magnetic flux sensor having a coil and detecting a voltage value generated in the coil. The detection voltage of the toner concentration sensor 131 changes according to the density of the magnetic flux from the toner in the developer container 74. That is, the processor 21 of the system controller 13 can calculate the toner concentration with respect to the toner carrier of the developer container 74, that is, the measured toner concentration value based on the detection voltage of the toner concentration sensor 131.

In addition, for example, in the example of FIG. 7, the plurality of toner concentration sensors 131 are provided on the outer wall surface of the developer container 74 and on the outer wall surface on the developing roller 76 side. The plurality of toner concentration sensors 131 are arranged at a plurality of locations in the main scanning direction on the outer wall surface of the developer container 74. Accordingly, the toner concentration sensor 77 can detect the toner concentration at each of the plurality of locations in the main scanning direction in the toner circulation path in the developer container 74. Accordingly, the processor 21 can control the toner replenishment mechanism so as to replenish a location where the toner concentration is low with the toner.

In addition, in the above-described embodiment, it has been described that the processor 21 replenishes with the toner by the toner replenishment mechanism based on the pixel count value, but the embodiment is not limited to this configuration. The processor 21 may control the toner replenishment mechanism so as to forcibly replenish with the toner based on the toner concentration in the developer container 74. For example, if the processor 21 determines that the toner concentration in the developer container 74 is less than a preset threshold value, the processor 21 determines that the remaining amount of toner in the developer container 74 is insufficient.

If the processor 21 determines that the toner concentration in the developer container 74 is less than a preset threshold value, the processor 21 operates the toner replenishment motor 51 for a predetermined time. If the toner replenishment motor 51 operates, the toner delivery mechanism 62 of the toner cartridge 2 is driven, and the toner in the toner storage container 61 is delivered to the developer container 74 of the developing device 73. Accordingly, the toner is replenished from the toner cartridge 2 to the developing device 73.

While certain embodiments have been described, these embodiments have been presented by way of example only, and are not intended to limit the scope of present disclosure. Indeed, the novel apparatus and methods described herein may be embodied in a variety of other forms; furthermore, various omissions, substitutions and changes in the form of the apparatus and methods described herein may be made without departing from the spirit of the present disclosure. The accompanying claims and their equivalents are intended to cover such forms or modifications as would fall within the scope and spirit of the present disclosure.

1. An image forming apparatus comprising:
an image carrier configured to hold an electrostatic latent image;
a developer configured to form a toner image by causing toner to adhere to the electrostatic latent image;
a toner replenisher configured to replenish the developer with the toner;
a toner conveyer configured to convey the replenished toner;
a toner concentration sensor configured to detect a concentration of the toner in the developer, the toner concentration sensor configured to detect the concentration within a detection range; and
a processor configured to:
determine a toner replenishment amount;
determine an estimated toner concentration value from the toner replenishment amount;
receive the concentration from the toner concentration sensor;
determine a measured toner concentration value based on the concentration;
cause the toner replenisher to replenish the developer with the toner replenishment amount;
determine a result of a comparison between the measured toner concentration value and the estimated toner concentration value;
control, based on the comparison result, at least one of the following while the processor is causing the toner replenisher to replenish the developer: (i) an operation of the toner replenisher, or (ii) an operation of the toner conveyer;
determine whether the replenished toner conveyed by the toner conveyer reached the detection range; and
control, after determining that the replenished toner is within the detection range, the at least one of: (i) the operation of the toner replenisher, or (ii) the operation of the toner conveyer.

2. (canceled)

3. The image forming apparatus of claim 1, wherein:
the developer comprises a toner replenishment port; and
the processor is further configured to determine whether the toner conveyed from the toner replenishment port reached the detection range based on:
a toner transfer speed of the toner conveyer,
a distance between the toner replenishment port and the detection range, and
a timing when the processor causes the toner replenisher to replenish the developer.

4. The image forming apparatus of claim 1, wherein the processor is further configured to:
cause the toner replenisher to replenish the developer with the toner replenishment amount over an operating time; and
select, based on the comparison result, at least one of: (i) the toner replenishment amount, or (ii) the operating time.

5. The image forming apparatus of claim 4, wherein:
the toner replenisher includes a motor configured to be driven to cause the developer to be replenished with the toner; and
the processor is further configured to:
cause the toner replenisher to replenish the developer with the toner replenishment amount by causing the motor to be driven at a speed selected based on the comparison result.

6. The image forming apparatus of claim 4, wherein the processor is further configured to:
cause the toner replenisher to replenish the developer with the toner replenishment amount after a replenishment interval has elapsed since causing the toner replenisher to replenish the developer with the toner replenishment amount; and
select the replenishment interval based on the comparison result.

7. The image forming apparatus of claim 1, wherein the processor is further configured to:
determine a pixel count value based on the electrostatic latent image; and
determine the toner replenishment amount based on the pixel count value.

8. The image forming apparatus of claim 1, wherein:
the processor is further configured to:
determine whether the concentration is within the detection range; and
cause the toner replenisher to replenish the developer with the toner replenishment amount after determining that the concentration is within the detection range.

9. The image forming apparatus of claim 1, wherein the processor is further configured to:
cause the toner concentration sensor to continuously detect the concentration;
determine a distribution of the concentration based on the concentration; and
cause the toner replenisher to replenish the developer with the toner replenishment amount based on the distribution.

10. An image forming unit for an image forming apparatus, the image forming unit comprising:
an image former comprising:
a developer container configured to store a toner;
a developing roller configured to rotate in the developer container;
a first toner conveyer having a first portion which extends within the developer container so as to be at least partially submerged within the toner stored in the developer container, the first toner conveyer configured to facilitate rotation of the first portion in a first rotational direction;
a second toner conveyer having a second portion which extends within the developer container so as to be at least partially submerged within the toner stored in the developer container, the second toner conveyer configured to facilitate rotation of the second portion in a second rotational direction that is opposite the first rotational direction;
a partition wall extending within the developer container between the first portion and the second portion, the partition wall and a wall of the developer container form a first space containing the first toner conveyer and a second space containing the second toner conveyer in the developer container, the first space being closer to the developing roller than the second space;
a first electrode coupled to the wall of the developer container of the first space and configured to interface with the toner stored in the developer container; and
a second electrode coupled to the wall of the developer container of the first space, separated from the first electrode, and configured to interface with the toner stored in the developer container; and
a processor configured to:
receive a first signal from the first electrode;
receive a second signal from the second electrode; and
determine a concentration value of the toner stored in the developer container according to a change in electrostatic capacitance between the first electrode and the second electrode.

11. (canceled)

12. The image forming unit of claim 10, wherein:
the first toner conveyer and the partition wall are disposed between the second toner conveyer and the first electrode; and
the first toner conveyer and the partition wall are disposed between the second toner conveyer and the second electrode.

13. The image forming unit of claim 10, further comprising:
a drum comprising a surface;
a charger configured to charge the surface;
a transfer roller disposed adjacent the drum; and
a transfer belt extending between the drum and the transfer roller;
wherein the image former further comprises a developer roller that is disposed adjacent the drum and configured to rotate within the developer container so as to facilitate transfer of the toner stored in the developer container to the drum.

14. The image forming unit of claim 13, wherein:
the image former further comprises:
a first motor that is configured to rotate the first toner conveyer; and
a second motor that is configured to rotate the second toner conveyer; and
the first toner conveyer and the second toner conveyer are each formed as an auger screw.

15. The image forming unit of claim 10, wherein rotation of the first portion and the second portion is configured to cause circulation of the toner stored within the developer container around the partition wall.

16. A method of replenishing toner within an image forming apparatus having a developer, a toner replenisher that is configured to replenish the developer with toner, a toner conveyer that is configured to convey the replenished toner, a toner concentration sensor that is configured to provide a signal indicative of a concentration of the toner in the developer, and a processor, the method comprising:
determining, by the processor, a toner replenishment amount;
determining, by the processor, an estimated toner concentration value from the toner replenishment amount;
receiving, by the processor, the signal from the toner concentration sensor;
determining, by the processor, the concentration based on the signal;
determining, the processor, a measured toner concentration value based on the concentration;
comparing, by the processor, the measured toner concentration value and the estimated toner concentration value;
causing, by the processor, the toner replenisher to replenish the developer with the toner replenishment amount over an operating time; and
selecting, by the processor, based on the comparison between the measured toner concentration value and the estimated toner concentration value, at least one of: (i) the toner replenishment amount, or (ii) the operating time.

17-18. (canceled)

19. The method of claim 16, further comprising:
causing, by the processor, the toner replenisher to replenish the developer with the toner replenishment amount after a replenishment interval has elapsed since causing the toner replenisher to replenish the developer with the toner replenishment amount; and
selecting, by the processor, based on the comparison between the measured toner concentration value and the estimated toner concentration value, the replenishment interval.

20. The method of claim 16, further comprising:
causing, by the processor, the toner concentration sensor to continuously detect the concentration;
determining, by the processor, a distribution of the concentration based on the concentration; and
causing, by the processor, the toner replenisher to replenish the developer with the toner replenishment amount based on the distribution.
